(19) United States
(12) Patent Application Publication
(10) Pub. No.: US 2022/0244498 A1
(43) Pub. Date: Aug. 4, 2022

(54) OPTICAL IMAGING LENS

(71) Applicant: GENIUS ELECTRONIC OPTICAL (XIAMEN) CO., LTD., Xiamen (CN)

(72) Inventors: Chuanbo Dong, Xiamen (CN); Jiayuan Zhang, Xiamen (CN); Huabin Liao, Xiamen (CN); Hung-Chien Hsieh, Xiamen (CN)

(73) Assignee: GENIUS ELECTRONIC OPTICAL (XIAMEN) CO., LTD., Xiamen (CN)

(21) Appl. No.: 17/199,441

(22) Filed: Mar. 12, 2021

(30) Foreign Application Priority Data
Feb. 2, 2021 (CN) 202110140942.X

(51) Int. Cl. G02B 13/00; G02B 9/12

(52) U.S. Cl. CPC G02B 13/0045; G02B 9/12

(57) ABSTRACT

An optical imaging lens, including a first lens element, a second lens element, and a third lens element sequentially disposed from an object side to an image side along an optical axis, is provided. Each of the first lens element to the third lens element includes an object-side surface that faces the object side and allows an imaging ray to pass through, and an image-side surface that faces the image side and allowing the imaging ray to pass through. A periphery region of the image-side surface of the first lens element is concave. An optical axis region of the object-side surface of the second lens element is concave. The third lens element has negative refracting power. Lens elements of the optical imaging lens are only the above three lens elements, and the optical imaging lens satisfies the following conditional expressions: HFOV/TTL≥16.000 degrees/mm and T1/T3≥1.350.

### CROSS-REFERENCE TO RELATED APPLICATION

This application claims the priority benefit of China application serial no. 202110140942.X, filed on Feb. 2, 2021. The entirety of the above-mentioned patent application is hereby incorporated by reference herein and made a part of this specification.

### BACKGROUND

### Technical Field

This disclosure relates to an optical component, and in particular to an optical imaging lens suitable for an infrared light waveband.

### Description of Related Art

The specifications of portable electronic devices have undergone rapid development and progression with new updates constantly. There is not only a continuous pursuit of lightness, thinness and miniaturization, but the specifications of key components of the electronic products such as an optical imaging lens has also been continuously improved to meet consumer needs. In addition to the imaging quality and size, it is also increasingly important to improve the field of view and the aperture size of the optical imaging lens. Therefore, in the field of optical imaging lens design, in addition to the pursuit of the thinness, the imaging quality and performance of the optical imaging lens must also be considered.

However, optical lens designing is not simply a matter of scaling down an optical imaging lens with good imaging quality to manufacture an optical imaging lens with both imaging quality and miniaturization. The design process not only involves material properties, but also practical production issues such as manufacturing and assembly yield.

Therefore, the technical difficulty of a miniaturized optical imaging lens is significantly higher than that of the traditional ones. As a result, how to manufacture an optical imaging lens that meets the needs of the consumer electronic products while continuously improving its imaging quality has remained a challenge for those skilled in the art.

### SUMMARY

This disclosure provides an optical imaging lens, which has a small F-number, a small size, a large field of view, and excellent imaging quality.

An embodiment of the disclosure provides an optical imaging lens, which includes a first lens element, a second lens element, and a third lens element sequentially disposed from an object side to an image side along an optical axis. Each of the first lens element to the third lens element includes an object-side surface that faces the object side and allows an imaging ray to pass through, and an image-side surface that faces the image side and allowing the imaging ray to pass through. A periphery region of the image-side surface of the first lens element is concave. An optical axis region of the object-side surface of the second lens element is concave. The third lens element has negative refracting power. Lens elements of the optical imaging lens are only the above three lens elements, and the optical imaging lens satisfies the following conditional expressions: HFOV/TTL 16.000 degrees/mm and T1/T3≥1.350, where HFOV is a half field of view of the optical imaging lens, TTL is a distance from the object-side surface of the first lens element to an image plane on the optical axis, T1 is a thickness of the first lens element on the optical axis, and T3 is a thickness of the third lens element on the optical axis.

An embodiment of the disclosure provides an optical imaging lens, which includes a first lens element, a second lens element, and a third lens element disposed sequentially from an object side to an image side along an optical axis. Each of the first lens element to the third lens element includes an object-side surface that faces the object side and allows an imaging ray to pass through, and an image-side surface that faces the image side and allows the imaging ray to pass through. The first lens element has positive refracting power, and a periphery region of the image-side surface is concave. The third lens element has negative refracting power. Lens elements of the optical imaging lens are only the above three lens elements, and the optical imaging lens satisfies the following conditional expressions: HFOV/TTL≥16.000 degrees/mm and T1/T3≥1.350, where HFOV is a half field of view of the optical imaging lens, TTL is a distance from the object-side surface of the first lens element to an image plane on the optical axis, T1 is a thickness of the first lens element on the optical axis, and T3 is a thickness of the third lens element on the optical axis.

An embodiment of the disclosure provides an optical imaging lens, which includes a first lens element, a second lens element, and a third lens element sequentially disposed from an object side to an image side along an optical axis. Each of the first lens element to the third lens element includes an object-side surface that faces the object side and allows an imaging ray to pass through, and an image-side surface that faces the image side and allows the imaging ray to pass through. An optical axis region of the image-side surface of the first lens element is concave. The third lens element has negative refracting power, and an optical axis region of the object-side surface is convex. Lens elements of the optical imaging lens are only the above three lens elements, and the optical imaging lens satisfies the following conditional expressions: HFOV/TTL 16.000 degrees/mm, T2/T3≥1.000 and |V2−V3|≤20.000, where HFOV is a half field of view of the optical imaging lens, TTL is a distance from the object-side surface of the first lens element to an image plane on the optical axis, T2 is a thickness of the second lens element on the optical axis, T3 is a thickness of the third lens element on the optical axis, V2 is an Abbe number of the second lens element, and V3 is an Abbe number of the third lens element.

Based on the above, one of the advantages of the optical imaging lens according to the embodiment of the disclosure includes enabling the optical imaging lens to simultaneously has a small F-number and a small size, while increasing the field of view and providing excellent imaging quality by having a design that satisfies the above concave-convex curved surface arrangement of the lens elements, the conditions of the refracting powers, and a design that satisfies the above conditional expressions.

### BRIEF DESCRIPTION OF THE DRAWINGS

FIG. 1 is a schematic diagram illustrating a surface structure of a lens element.

FIG. 2 is a schematic diagram illustrating a concave-convex surface structure and a focal point of light of a lens element.

FIG. 3 is a schematic diagram illustrating a surface structure of a lens element of Example 1.

FIG. 4 is a schematic diagram illustrating a surface structure of a lens element of Example 2.

FIG. 5 is a schematic diagram illustrating a surface structure of a lens element of Example 3.

FIG. 6 is a schematic diagram of an optical imaging lens according to a first embodiment of the disclosure.

FIGS. 7A to 7D are diagrams of the longitudinal spherical aberration and various aberrations of the optical imaging lens according to the first embodiment.

FIG. 8 shows detailed optical data of the optical imaging lens according to the first embodiment of the disclosure.

FIG. 9 shows the aspheric surface parameters of the optical imaging lens according to the first embodiment of the disclosure.

FIG. 10 is a schematic diagram of an optical imaging lens according to a second embodiment of the disclosure.

FIGS. 11A to 11D are diagrams of the longitudinal spherical aberration and various aberrations of the optical imaging lens according to the second embodiment.

FIG. 12 shows detailed optical data of the optical imaging lens according to the second embodiment of the disclosure.

FIG. 13 shows the aspheric surface parameters of the optical imaging lens according to the second embodiment of the disclosure.

FIG. 14 is a schematic diagram of an optical imaging lens according to a third embodiment of the disclosure.

FIGS. 15A to 15D are diagrams of the longitudinal spherical aberration and various aberrations of the optical imaging lens according to the third embodiment.

FIG. 16 shows detailed optical data of the optical imaging lens according to the third embodiment of the disclosure.

FIG. 17 shows the aspheric surface parameters of the optical imaging lens according to the third embodiment of the disclosure.

FIG. 18 is a schematic diagram of an optical imaging lens according to a fourth embodiment of the disclosure.

FIGS. 19A to 19D are diagrams of the longitudinal spherical aberration and various aberrations of the optical imaging lens according to the fourth embodiment.

FIG. 20 shows detailed optical data of the optical imaging lens according to the fourth embodiment of the disclosure.

FIG. 21 shows the aspheric surface parameters of the optical imaging lens according to the fourth embodiment of the disclosure.

FIG. 22 is a schematic diagram of an optical imaging lens according to a fifth embodiment of the disclosure.

FIGS. 23A to 23D are diagrams of the longitudinal spherical aberration and various aberrations of the optical imaging lens according to the fifth embodiment.

FIG. 24 shows detailed optical data of the optical imaging lens according to the fifth embodiment of the disclosure.

FIG. 25 shows the aspheric surface parameters of the optical imaging lens according to the fifth embodiment of the disclosure.

FIG. 26 is a schematic diagram of an optical imaging lens according to a sixth embodiment of the disclosure.

FIGS. 27A to 27D are diagrams of the longitudinal spherical aberration and various aberrations of the optical imaging lens according to the sixth embodiment.

FIG. 28 shows detailed optical data of the optical imaging lens according to the sixth embodiment of the disclosure.

FIG. 29 shows the aspheric surface parameters of the optical imaging lens according to the sixth embodiment of the disclosure.

FIG. 30 is a schematic diagram of an optical imaging lens according to a seventh embodiment of the disclosure.

FIGS. 31A to 31D are diagrams of the longitudinal spherical aberration and various aberrations of the optical imaging lens according to the seventh embodiment.

FIG. 32 shows detailed optical data of the optical imaging lens according to the seventh embodiment of the disclosure.

FIG. 33 shows the aspheric surface parameters of the optical imaging lens according to the seventh embodiment of the disclosure.

FIG. 34 is a schematic diagram of an optical imaging lens of an eighth embodiment of the disclosure.

FIGS. 35A to 35D are diagrams of the longitudinal spherical aberration and various aberrations of the optical imaging lens according to the eighth embodiment.

FIG. 36 shows detailed optical data of the optical imaging lens according to the eighth embodiment of the disclosure.

FIG. 37 shows the aspheric surface parameters of the optical imaging lens according to the eighth embodiment of the disclosure.

FIGS. 38 and 39 show the values of important parameters of the optical imaging lens and their relational values according to the first to the eighth embodiments of the disclosure.

### DESCRIPTION OF THE EMBODIMENTS

The terms “optical axis region”, “periphery region”, “concave”, and “convex” used in this specification and claims should be interpreted based on the definition listed in the specification by the principle of lexicographer.

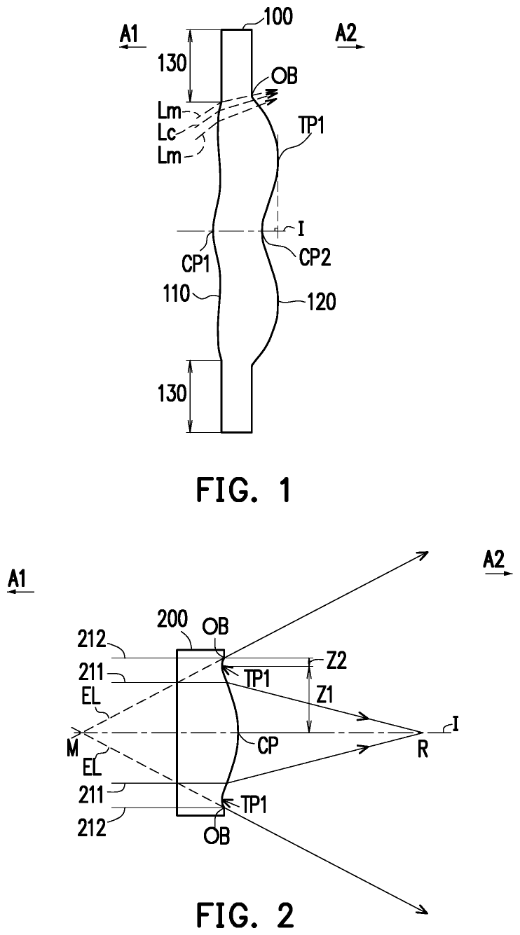

In the present disclosure, the optical system may comprise at least one lens element to receive imaging rays that are incident on the optical system over a set of angles ranging from parallel to an optical axis to a half field of view (HFOV) angle with respect to the optical axis. The imaging rays pass through the optical system to produce an image on an image plane. The term “a lens element having positive refracting power (or negative refracting power)” means that the paraxial refracting power of the lens element in Gaussian optics is positive (or negative). The term “an object-side (or image-side) surface of a lens element” refers to a specific region of that surface of the lens element at which imaging rays can pass through that specific region. Imaging rays include at least two types of rays: a chief ray Lc and a marginal ray Lm (as shown in FIG. 1). An object-side (or image-side) surface of a lens element can be characterized as having several regions, including an optical axis region, a periphery region, and, in some cases, one or more intermediate regions, as discussed more fully below.

FIG. 1 is a radial cross-sectional view of a lens element 100. Two referential points for the surfaces of the lens element 100 can be defined: a central point, and a transition point. The central point of a surface of a lens element is a point of intersection of that surface and the optical axis I. As illustrated in FIG. 1, a first central point CP1 may be present on the object-side surface 110 of lens element 100 and a second central point CP2 may be present on the image-side surface 120 of the lens element 100. The transition point is a point on a surface of a lens element, at which the line tangent to that point is perpendicular to the optical axis I. The optical boundary OB of a surface of the lens element is defined as a point at which the radially outermost marginal ray Lm passing through the surface of the lens element intersects the surface of the lens element. All transition points lie between the optical axis I and the optical boundary OB of the surface of the lens element. A surface of the lens element 100 may have no transition point or have at least one transition point. If multiple transition points are present on a single surface, then these transition points are sequentially named along the radial direction of the surface with reference numerals starting from the first transition point. For example, the first transition point, e.g., TP1, (closest to the optical axis I), the second transition point, e.g., TP2, (as shown in FIG. 4), and the Nth transition point (farthest from the optical axis I).

When a surface of the lens element has at least one transition point, the region of the surface of the lens element from the central point to the first transition point TP1 is defined as the optical axis region, which includes the central point. The region located radially outside of the farthest transition point (the Nth transition point) from the optical axis I to the optical boundary OB of the surface of the lens element is defined as the periphery region. In some embodiments, there may be intermediate regions present between the optical axis region and the periphery region, with the number of intermediate regions depending on the number of the transition points. When a surface of the lens element has no transition point, the optical axis region is defined as a region of 0%-50% of the distance between the optical axis I and the optical boundary OB of the surface of the lens element, and the periphery region is defined as a region of 50%-100% of the distance between the optical axis I and the optical boundary OB of the surface of the lens element.

The shape of a region is convex if a collimated ray being parallel to the optical axis I and passing through the region is bent toward the optical axis I such that the ray intersects the optical axis Ion the image side A2 of the lens element. The shape of a region is concave if the extension line of a collimated ray being parallel to the optical axis I and passing through the region intersects the optical axis Ion the object side A1 of the lens element.

Additionally, referring to FIG. 1, the lens element 100 may also have a mounting portion 130 extending radially outward from the optical boundary OB. The mounting portion 130 is typically used to physically secure the lens element to a corresponding element of the optical system (not shown). Imaging rays do not reach the mounting portion 130. The structure and shape of the mounting portion 130 are only examples to explain the technologies, and should not be taken as limiting the scope of the present disclosure. The mounting portion 130 of the lens elements discussed below may be partially or completely omitted in the following drawings.

Referring to FIG. 2, optical axis region Z1 is defined between central point CP and first transition point TP1. Periphery region Z2 is defined between TP1 and the optical boundary OB of the surface of the lens element. Collimated ray 211 intersects the optical axis I on the image side A2 of lens element 200 after passing through the optical axis region Z1, i.e., the focal point of collimated ray 211 after passing through optical axis region Z1 is on the image side A2 of the lens element 200 at point R in FIG. 2. Accordingly, since the ray itself intersects the optical axis I on the image side A2 of the lens element 200, optical axis region Z1 is convex. On the contrary, collimated ray 212 diverges after passing through periphery region Z2. The extension line EL of collimated ray 212 after passing through periphery region Z2 intersects the optical axis I on the object side A1 of lens element 200, i.e., the focal point of collimated ray 212 after passing through periphery region Z2 is on the object side A1 at point M in FIG. 2. Accordingly, since the extension line EL of the ray intersects the optical axis I on the object side A1 of the lens element 200, periphery region Z2 is concave. In the lens element 200 illustrated in FIG. 2, the first transition point TP1 is the border of the optical axis region and the periphery region, i.e., TP1 is the point at which the shape changes from convex to concave.

Alternatively, there is another way for a person having ordinary skill in the art to determine whether an optical axis region is convex or concave by referring to the sign of “Radius of curvature” (the “R” value), which is the paraxial radius of shape of a lens surface in the optical axis region. The R value is commonly used in conventional optical design software such as Zemax and CodeV. The R value usually appears in the lens data sheet in the software. For an object-side surface, a positive R value defines that the optical axis region of the object-side surface is convex, and a negative R value defines that the optical axis region of the object-side surface is concave. Conversely, for an image-side surface, a positive R value defines that the optical axis region of the image-side surface is concave, and a negative R value defines that the optical axis region of the image-side surface is convex. The result found by using this method should be consistent with the method utilizing intersection of the optical axis by rays/extension lines mentioned above, which determines surface shape by referring to whether the focal point of a collimated ray being parallel to the optical axis I is on the object-side or the image-side of a lens element. As used herein, the terms “a shape of a region is convex (concave)”, “a region is convex (concave)”, and “a convex-(concave-) region”, can be used alternatively.

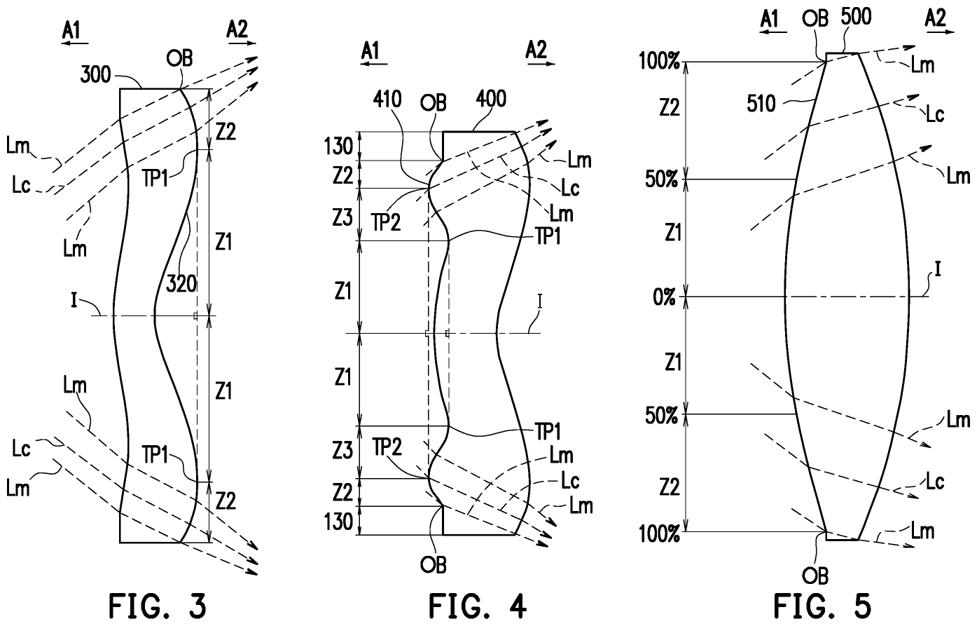

FIG. 3, FIG. 4 and FIG. 5 illustrate examples of determining the shape of lens element regions and the boundaries of regions under various circumstances, including the optical axis region, the periphery region, and intermediate regions as set forth in the present specification.

FIG. 3 is a radial cross-sectional view of a lens element 300. As illustrated in FIG. 3, only one transition point TP1 appears within the optical boundary OB of the image-side surface 320 of the lens element 300. Optical axis region Z1 and periphery region Z2 of the image-side surface 320 of lens element 300 are illustrated. The R value of the image-side surface 320 is positive (i.e., R>0). Accordingly, the optical axis region Z1 is concave.

In general, the shape of each region demarcated by the transition point will have an opposite shape to the shape of the adjacent region(s). Accordingly, the transition point will define a transition in shape, changing from concave to convex at the transition point or changing from convex to concave. In FIG. 3, since the shape of the optical axis region Z1 is concave, the shape of the periphery region Z2 will be convex as the shape changes at the transition point TP1.

FIG. 4 is a radial cross-sectional view of a lens element 400. Referring to FIG. 4, a first transition point TP1 and a second transition point TP2 are present on the object-side surface 410 of lens element 400. The optical axis region Z1 of the object-side surface 410 is defined between the optical axis I and the first transition point TP1. The R value of the object-side surface 410 is positive (i.e., R>0). Accordingly, the optical axis region Z1 is convex.

The periphery region Z2 of the object-side surface 410, which is also convex, is defined between the second transition point TP2 and the optical boundary OB of the object-side surface 410 of the lens element 400. Further, intermediate region Z3 of the object-side surface 410, which is concave, is defined between the first transition point TP1 and the second transition point TP2. Referring once again to FIG. 4, the object-side surface 410 includes an optical axis region Z1 located between the optical axis I and the first transition point TP1, an intermediate region Z3 located between the first transition point TP1 and the second transition point TP2, and a periphery region Z2 located between the second transition point TP2 and the optical boundary OB of the object-side surface 410. Since the shape of the optical axis region Z1 is designed to be convex, the shape of the intermediate region Z3 is concave as the shape of the intermediate region Z3 changes at the first transition point TP1, and the shape of the periphery region Z2 is convex as the shape of the periphery region Z2 changes at the second transition point TP2.

FIG. 5 is a radial cross-sectional view of a lens element 500. Lens element 500 has no transition point on the object-side surface 510 of the lens element 500. For a surface of a lens element with no transition point, for example, the object-side surface 510 of the lens element 500, the optical axis region Z1 is defined as the region of 0%-50% of the distance between the optical axis I and the optical boundary OB of the surface of the lens element and the periphery region is defined as the region of 50%-100% of the distance between the optical axis I and the optical boundary OB of the surface of the lens element. Referring to lens element 500 illustrated in FIG. 5, the optical axis region Z1 of the object-side surface 510 is defined between the optical axis I and 50% of the distance between the optical axis I and the optical boundary OB. The R value of the object-side surface 510 is positive (i.e., R>0). Accordingly, the optical axis region Z1 is convex. For the object-side surface 510 of the lens element 500, because there is no transition point, the periphery region Z2 of the object-side surface 510 is also convex. It should be noted that lens element 500 may have a mounting portion (not shown) extending radially outward from the periphery region Z2.

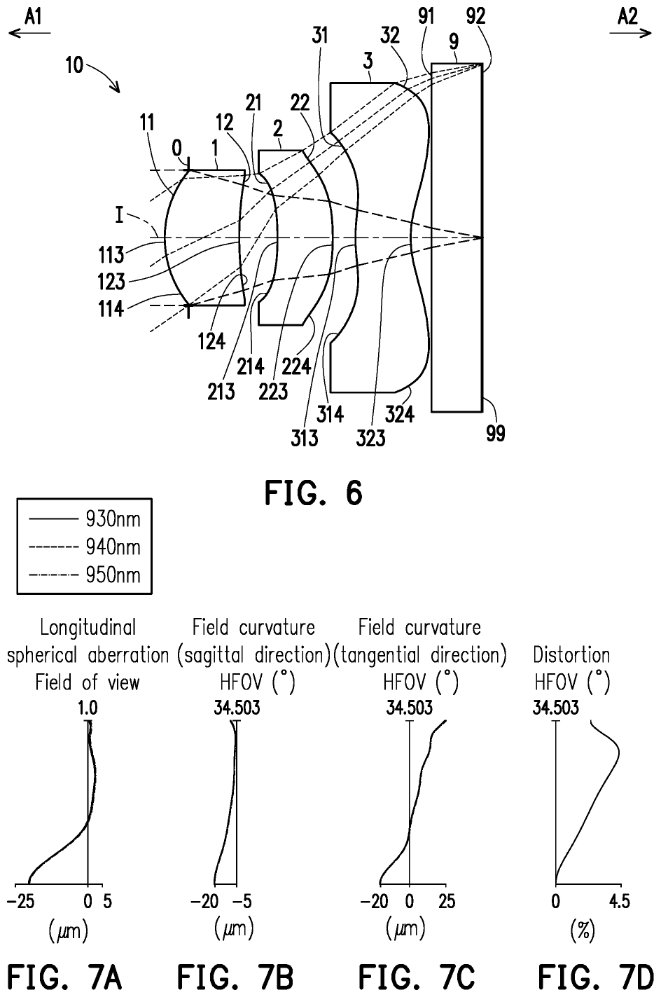

FIG. 6 is a schematic diagram of an optical imaging lens according to a first embodiment of the disclosure, and FIGS. 7A to 7D are diagrams of the longitudinal spherical aberration and various aberrations of the optical imaging lens according to the first embodiment. Referring to FIG. 6, the optical imaging lens 10 according to the first embodiment of the disclosure includes a first lens element 1, a second lens element 2, a third lens element 3, and a filter 9 sequentially disposed along the optical axis I of the optical imaging lens 10 from the object side A1 to the image side A2. An aperture 0 is disposed between an object-side surface 11 of the first lens element 1 and an object to be photographed (not shown). When an imaging ray emitted by the object to be photographed enters the optical imaging lens 10 and passes through the aperture 0, the first lens element 1, the second lens element 2, the third lens element 3 and the filter 9, an image is formed on an image plane 99. The filter 9 is disposed between an image-side surface 32 of the third lens element 3 and the image plane 99. It should be noted that the object side A1 is a side facing the object to be photographed, and the image side A2 is a side facing the image plane 99. In an embodiment, the filter 9 may be a visible light cut filter, but the disclosure is not limited thereto.

In the embodiment, each of the first lens element 1, the second lens element 2, the third lens element 3, and the filter 9 of the optical imaging lens 10 respectively have an object-side surface 11, 21, 31, 91 that faces the object side A1 and allows the imaging ray to pass through, and an image-side surface 12, 22, 32, 92 that faces the image side A2 and allows the imaging ray to pass through.

In the embodiment, the first lens element 1 has positive refracting power. The material of the first lens element 1 may be plastic or glass, but the material of the first lens element 1 is preferably plastic. An optical axis region 113 of the object-side surface 11 of the first lens element 1 is convex, and a periphery region 114 of the object-side surface 11 of the first lens element 1 is convex. An optical axis region 123 of the image-side surface 12 of the first lens element 1 is concave, and a periphery region 124 of the image-side surface 12 of the first lens element 1 is concave. In the embodiment, both the object-side surface 11 and the image-side surface 12 of the first lens element 1 are aspheric surfaces, but the disclosure is not limited thereto.

The second lens element 2 has positive refracting power. The material of the second lens element 2 may be plastic or glass, but the material of the second lens element 2 is preferably plastic. An optical axis region 213 of the object-side surface 21 of the second lens element 2 is concave, and a periphery region 214 of the object-side surface 21 of the second lens element 2 is concave. An optical axis region 223 of the image-side surface 22 of the second lens element 2 is convex, and a periphery region 224 of the image-side surface 22 of the second lens element 2 is convex. In the embodiment, both the object-side surface 21 and the image-side surface 22 of the second lens element 2 are aspheric surfaces, but the disclosure is not limited to this.

The third lens element 3 has negative refracting power. The material of the third lens element 3 may be plastic or glass, but the material of the third lens element 3 is preferably plastic. An optical axis region 313 of the object-side surface 31 of the third lens element 3 is convex, and a periphery region 314 of the object-side surface 31 of the third lens element 3 is concave. An optical axis region 323 of the image-side surface 32 of the third lens element 3 is concave, and a periphery region 324 of the image-side surface 32 of the third lens element 3 is convex. In the embodiment, the object-side surface 31 and the image-side surface 32 of the third lens element 3 are both aspheric surfaces, but the disclosure is not limited thereto.

In the embodiment, lens elements of the optical imaging lens 10 are only the above three lens elements.

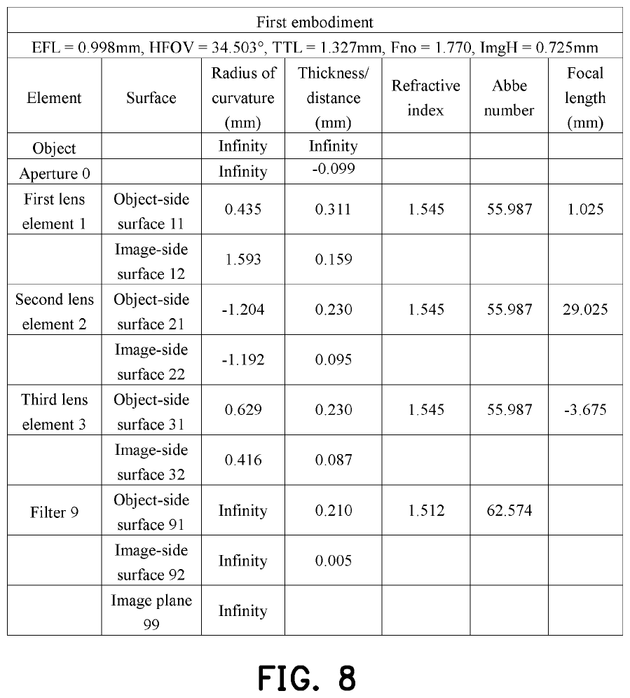

Other detailed optical data of the first embodiment is shown in FIG. 8. An effective focal length (EFL) of the optical imaging lens 10 according to the first embodiment is 0.998 millimeters (mm), the half field of view (HFOV) is 34.503 degrees, an F-number (Fno) is 1.770, a system length is 1.327 mm, and an image height is 0.725 mm. The system length refers to a distance from the object-side surface 11 of the first lens element 1 to the image plane 99 on the optical axis I.

In addition, in the embodiment, the object-side surfaces 11, 21, 31 and the image-side surfaces 12, 22, 32 of the first lens element 1, the second lens element 2, and the third lens element 3 are aspheric surfaces. The object-side surface 11, 21, 31 and the image-side surface 12, 22, 32 are common even aspheric surfaces. These aspheric surfaces are defined by the following formula:

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {a}_{i} \times {Y}^{i} \qquad ( 1 )$$

where,

R: a radius of curvature of the lens element surface near to the optical axis I,

Z: a depth of the aspheric surface (a vertical distance between the point Y from the optical axis I on the aspheric surface and the tangent to the vertex on the optical axis I of the aspheric surface),

Y: a distance between a point on the aspheric surface curvature and the optical axis I, K: a conic constant, and an i-th aspheric surface coefficient.

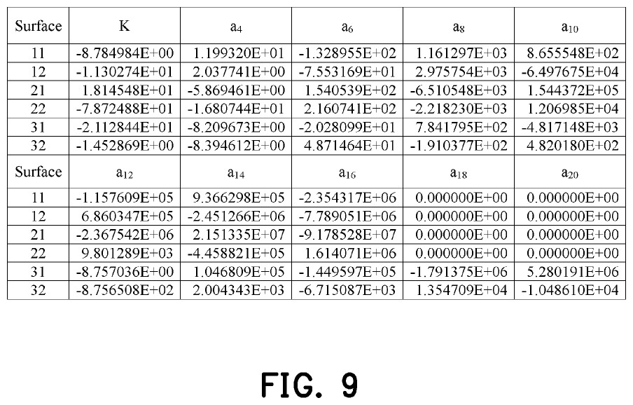

The aspheric surface coefficients of the object-side surface 11 of the first lens element 1 to the image-side surface 32 of the third lens element 3 in the formula (1) are shown in FIG. 9. The field number 11 in FIG. 9 indicates that it is the aspheric surface coefficient of the object-side surface 11 of the first lens element 1, and the other fields may be deduced by analogy accordingly. In this embodiment and the following embodiments, a second-order aspheric surface coefficient a₂ is zero.

In addition, relationships between the important parameters of the optical imaging lens 10 according to the first embodiment are shown in FIG. 38, where,

T1 is a thickness of the first lens element 1 on the optical axis I,

T2 is a thickness of the second lens element 2 on the optical axis I,

T3 is a thickness of the third lens element 3 on the optical axis I,

G12 is an air gap between the first lens element 1 and the second lens element 2 on the optical axis I, and it is also a distance between the image-side surface 12 of the first lens element 1 and the object-side surface 21 of the second lens element 2 on the optical axis I,

G23 is an air gap between the second lens element 2 and the third lens element 3 on the optical axis I, and it is also a distance between the image-side surface 22 of the second lens element 2 and the object-side surface 31 of the third lens element 3 on the optical axis I,

AAG is a sum of the two air gaps from the first lens element 1 to the third lens element 3 on the optical axis I, that is, the sum of the air gaps G12 and G23,

ALT is a sum of the thicknesses of the three lens elements, from the first lens element 1 to the third lens element 3 on the optical axis I, that is, the sum of T1, T2, and T3,

Tₘₐₓ is a maximum value of the three lens element thicknesses of the first lens element 1 to the third lens element 3 on the optical axis I, that is, the maximum value among T1, T2 and T3,

Tₘᵢₙ is a minimum value of the three lens element thicknesses of the first lens element 1 to the third lens element 3 on the optical axis I, that is, the minimum value among T1, T2 and T3,

TL is a distance from the object-side surface 11 of the first lens element 1 to the image-side surface 32 of the third lens element 3 on the optical axis I,

TTL is a distance from the object-side surface 11 of the first lens element 1 to the image plane 99 on the optical axis I,

BFL is a distance from the image-side surface 32 of the third lens element 3 to the image plane 99 on the optical axis I,

EFL is the effective focal length of the optical imaging lens 10,

HFOV is the half field of view of the optical imaging lens 10,

ImgH is an image height of the optical imaging lens 10, and

Fno is an F-number of the optical imaging lens 10.

In addition, the following parameters are further defined, where

G3F is an air gap between the third lens element 3 and the filter 9 on the optical axis I, and it is also a distance from the image-side surface 32 of the third lens element 3 to the object-side surface 91 of the filter 9 on the optical axis I,

TF is a thickness of the filter 9 on the optical axis I,

GFP is an air gap between the filter 9 and the image plane 99 on the optical axis I, and it is also a distance from the image-side surface 92 of the filter 9 to the image plane 99 on the optical axis I,

f1 is a focal length of the first lens element 1,

f2 is a focal length of the second lens element 2,

f3 is a focal length of the third lens element 3,

n1 is a refractive index of the first lens element 1,

n2 is a refractive index of the second lens element 2,

n3 is a refractive index of the third lens element 3,

V1 is an Abbe number of the first lens element 1, and the Abbe number may also be known as a color dispersion coefficient,

V2 is an Abbe number of the second lens element 2,

V3 is an Abbe number of the third lens element 3.

And referring to FIGS. 7A to 7D, FIG. 7A illustrates the longitudinal spherical aberration of the first embodiment, FIGS. 7B and 7C respectively illustrate a field curvature aberration in a sagittal direction and a field curvature aberration in a tangential direction on the image plane 99 according to the first embodiment when the wavelength are 930 nm, 940 nm and 950 nm, and FIG. 7D illustrates a distortion aberration on the image plane 99 according to the first embodiment when the wavelengths are 930 nm, 940 nm and 950 nm. The longitudinal spherical aberration of the first embodiment is shown in FIG. 8A, in which a curve formed by each wavelength is very close to other curves and approaches the middle, illustrating that off-axis rays at different heights of each wavelength are concentrated near an imaging point. It can be seen from deflection amplitude of the curve of each wavelength that a deviation of the imaging point of the off-axis rays at the different heights is controlled within a range of ±25 micrometers (μm), therefore the embodiment does significantly improve the spherical aberration of the same wavelength. In addition, distances between the three representative wavelengths are also quite close to each other, indicating that imaging positions of rays of the different wavelengths are already quite concentrated, thus, significantly improving chromatic aberration.

In the two field curvature aberration diagrams of FIGS. 7B and 7C, an amount of focal length variation of the three representative wavelengths in an entire field of view falls within a range of ±25 μm. This illustrates that the optical system according to the first embodiment can effectively eliminate aberration. The distortion aberration diagram of FIG. 7D shows that the distortion aberration of the first embodiment is maintained within a range of ±4.5%, indicating that the distortion aberration of the first embodiment has met the imaging quality requirements of the optical system. Accordingly, it illustrates that compared with a conventional optical imaging lens, the first embodiment can still provide good imaging quality under a condition of the system length being shortened to 1.327 mm. Therefore, the first embodiment can lower the F-number, reduce the size, increase the field of view and meet the imaging quality simultaneously while maintaining good optical performance.

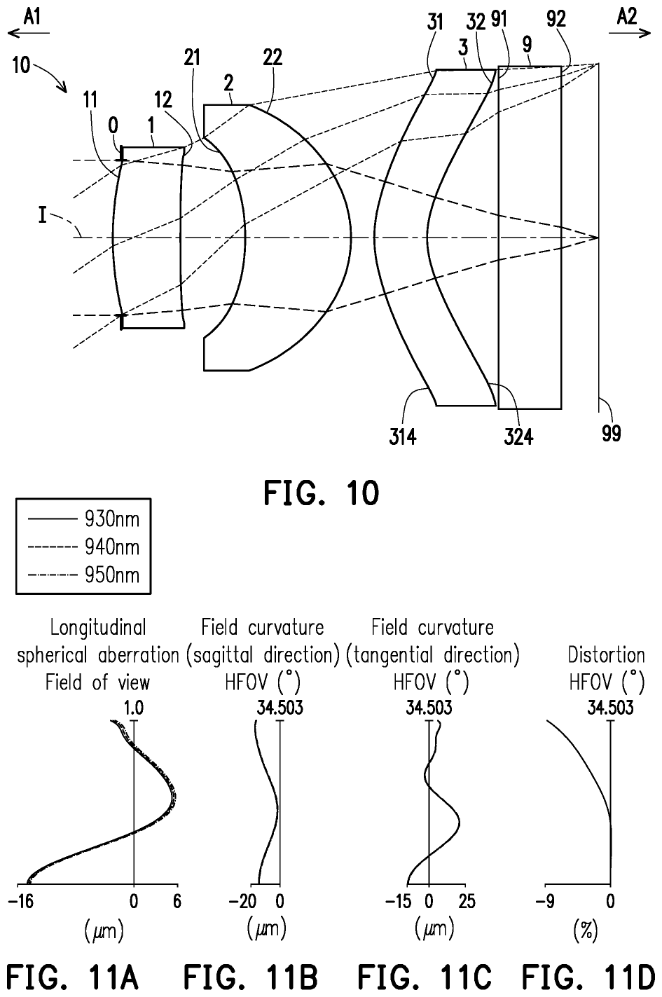

FIG. 10 is a schematic diagram of an optical imaging lens according to a second embodiment of the disclosure, and FIGS. 11A to 11D are diagrams of the longitudinal spherical aberration and various aberrations of the optical imaging lens according to the second embodiment. Referring to FIG. 10 first, the second embodiment of the optical imaging lens 10 of the disclosure is roughly similar to the first embodiment, except for the optical data, the aspheric surface coefficients, and the parameters of the lens elements 1, 2, and 3, which are more or less different. In addition, in the embodiment, the periphery region 314 of the object-side surface 31 of the third lens element 3 is convex. The periphery region 324 of the image-side surface 32 of the third lens element 3 is concave. It should be noted here that, in order to clearly show the drawing, some of the reference numerals of the optical axis region and the periphery region similar to the first embodiment are omitted in FIG. 10.

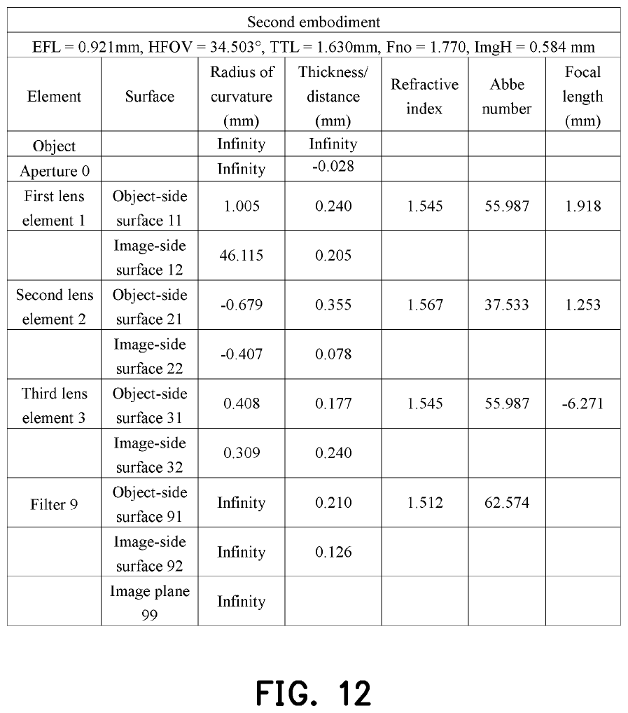

The detailed optical data of the optical imaging lens 10 according to the second embodiment is shown in FIG. 12. The effective focal length of the optical imaging lens 10 according to the second embodiment is 0.921 mm, the half field of view (HFOV) is 34.503 degrees, the F-number (Fno) is 1.770, the system length is 1.630 mm, and the image height is 0.584 mm.

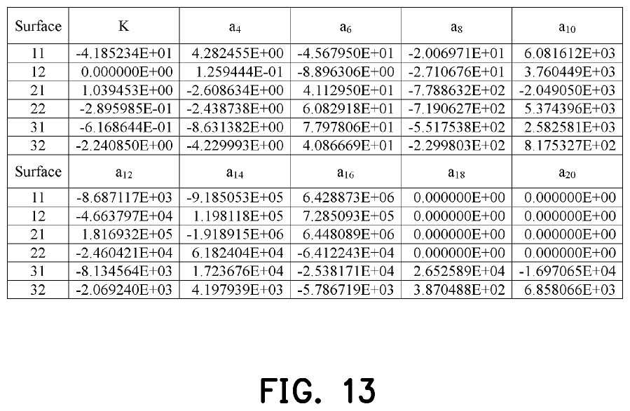

The aspheric surface coefficients of the object-side surface 11 of the first lens element 1 to the image-side surface 32 of the third lens element 3 according to the second embodiment in the formula (1) are shown in FIG. 13.

In addition, relationships between the important parameters of the optical imaging lens 10 according to the second embodiment are shown in FIG. 38.

The longitudinal spherical aberration of the second embodiment is shown in FIG. 11A, and the deviation of the imaging point of the off-axis rays at the different heights is controlled within a range of ±16 μm. In the two field curvature aberration diagrams of FIGS. 11B and 11C, the amount of the focal length variation of the three representative wavelengths in the entire field of view falls within ±25 μm. The distortion aberration diagram of FIG. 11D shows that the distortion aberration of the second embodiment is maintained within a range of ±9%.

It may be seen from the above description that the longitudinal spherical aberration of the second embodiment is better than that of the first embodiment.

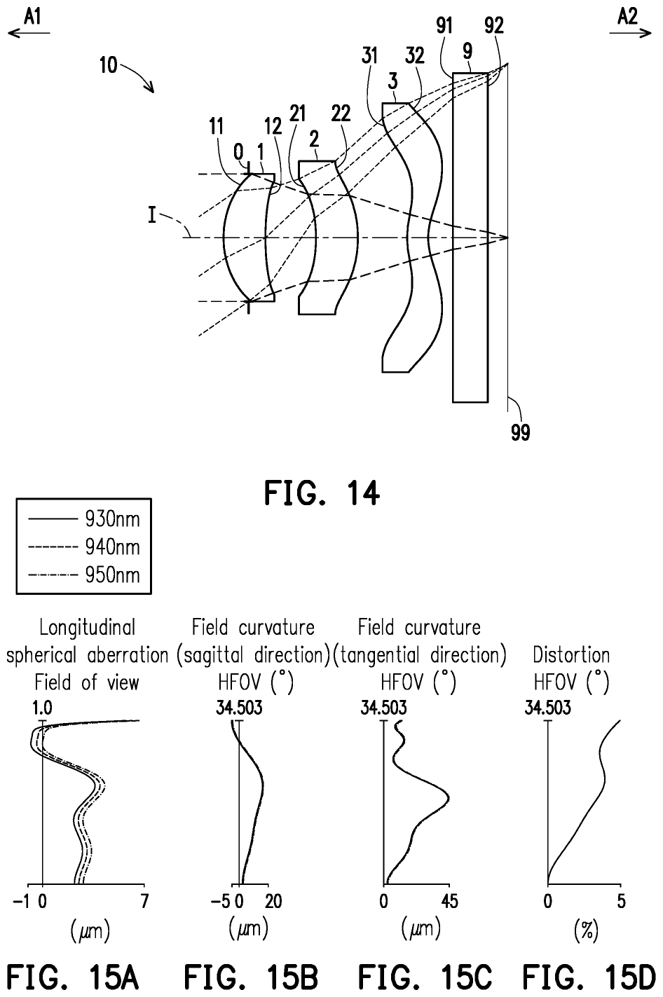

FIG. 14 is a schematic diagram of an optical imaging lens according to a third embodiment of the disclosure, and FIGS. 15A to 15D are diagrams of the longitudinal spherical aberration and various aberrations of the optical imaging lens according to the third embodiment. Referring to FIG. 14 first, the third embodiment of the optical imaging lens 10 of the disclosure is roughly similar to the first embodiment, except for the optical data, the aspheric surface coefficients, and the parameters of the lens elements 1, 2, and 3, which are more or less different. It should be noted here that, in order to clearly show the drawing, some of the reference numerals of the optical axis region and the periphery region similar to the first embodiment are omitted in FIG. 14.

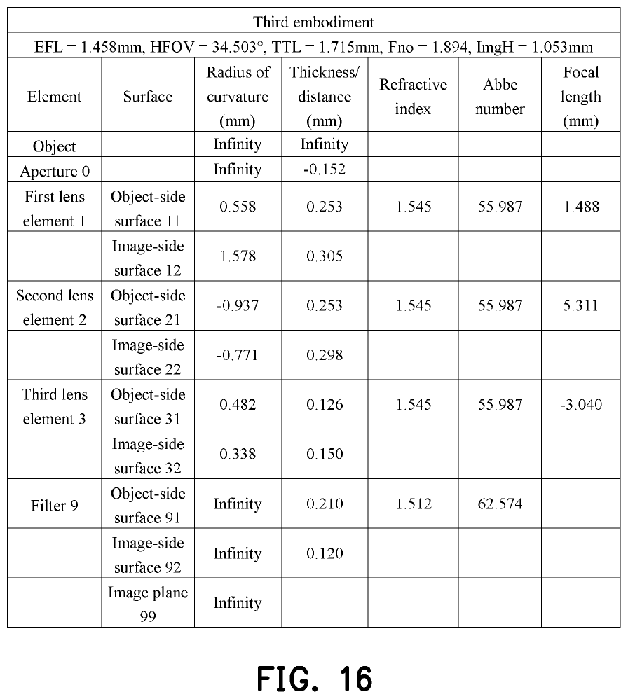

The detailed optical data of the optical imaging lens 10 according to the third embodiment is shown in FIG. 16. The effective focal length of the optical imaging lens 10 according to the third embodiment is 1.458 mm, the half field of view (HFOV) is 34.503 degrees, the F-number (Fno) is 1.894, the system length is 1.715 mm, and the image height is 1.053 mm.

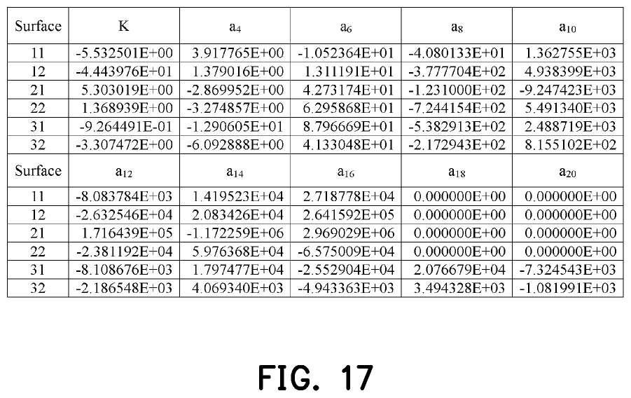

The aspheric surface coefficients of the object-side surface 11 of the first lens element 1 to the image-side surface 32 of the third lens element 3 according to the third embodiment in the formula (1) are shown in FIG. 17.

In addition, relationships between the important parameters of the optical imaging lens 10 according to the third embodiment are shown in FIG. 38.

The longitudinal spherical aberration of the third embodiment is shown in FIG. 15A, and the deviation of the imaging point of the off-axis rays at the different heights is controlled within a range of ±7 μm. In the two field curvature aberration diagrams of FIGS. 15B and 15C, the amount of the focal length variation of the three representative wavelengths in the entire field of view falls within ±45 μm. The distortion aberration diagram of FIG. 15D shows that the distortion aberration of the third embodiment is maintained within a range of ±5%.

It may be seen from the above description that the longitudinal spherical aberration of the third embodiment is better than that of the first embodiment.

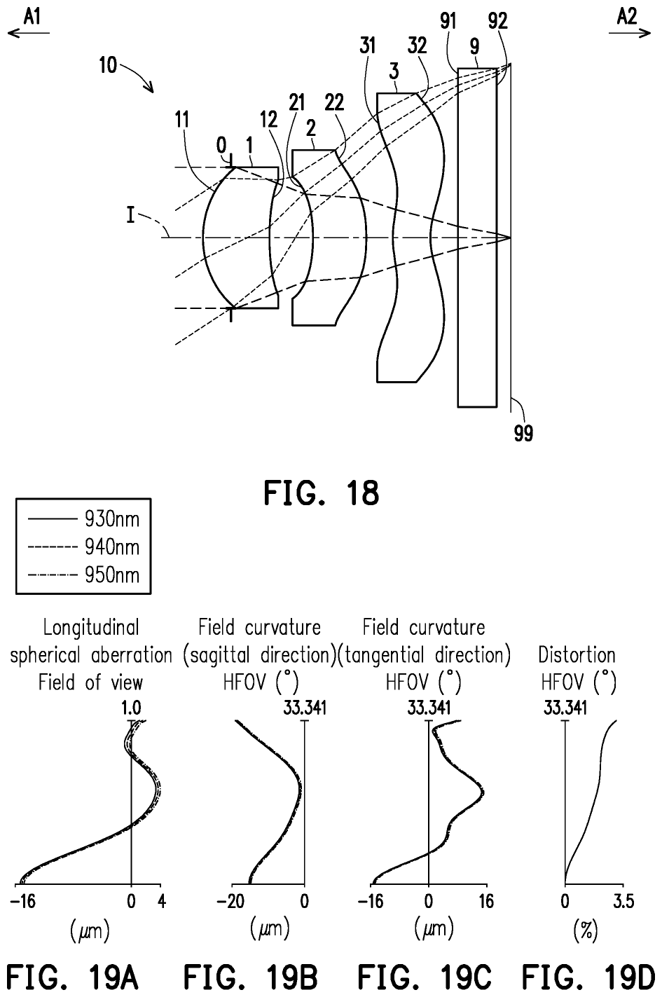

FIG. 18 is a schematic diagram of an optical imaging lens according to a fourth embodiment of the disclosure, and FIGS. 19A to 19D are diagrams of the longitudinal spherical aberration and various aberrations of the optical imaging lens according to the fourth embodiment. Referring to FIG. 18 first, the fourth embodiment of the optical imaging lens 10 of the disclosure is roughly similar to the first embodiment, except for the optical data, the aspheric surface coefficients, and the parameters of the lens elements 1, 2, and 3, which are more or less different. In addition, in the embodiment, the second lens element 2 has negative refracting power. It should be noted here that, in order to clearly show the drawing, some of the reference numerals of the optical axis region and the periphery region similar to the first embodiment are omitted in FIG. 18.

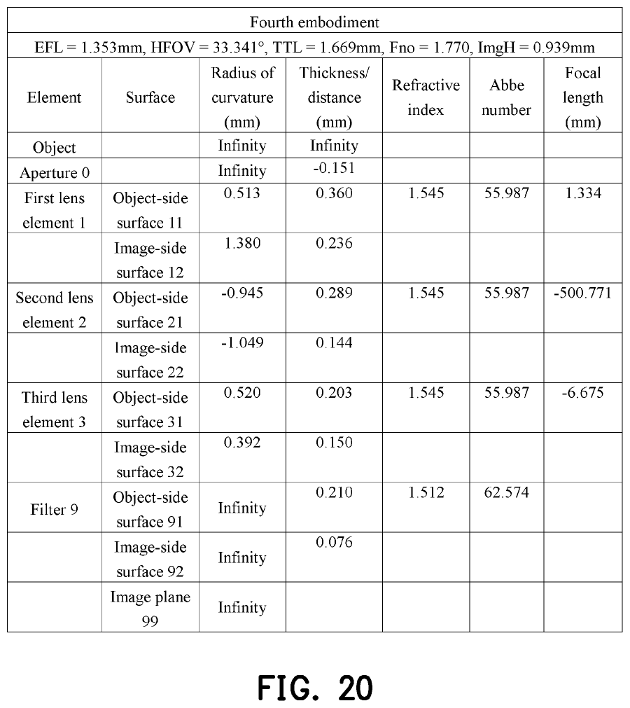

The detailed optical data of the optical imaging lens 10 according to the fourth embodiment is shown in FIG. 20. The effective focal length of the optical imaging lens 10 according to the fourth embodiment is 1.353 mm, the half field of view (HFOV) is 33.341 degrees, the F-number (Fno) is 1.770, the system length is 1.669 mm, and the image height is 0.939 mm.

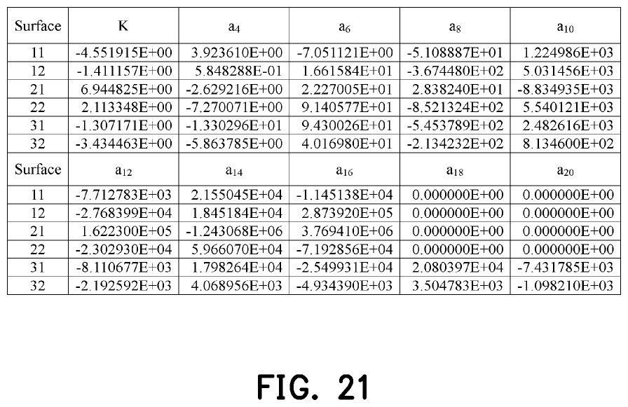

The aspheric surface coefficients of the object-side surface 11 of the first lens element 1 to the image-side surface 32 of the third lens element 3 according to the fourth embodiment in the formula (1) are shown in FIG. 21.

In addition, relationships between the important parameters of the optical imaging lens 10 according to the fourth embodiment are shown in FIG. 38.

The longitudinal spherical aberration of the fourth embodiment is shown in FIG. 19A, and the deviation of the imaging point of the off-axis rays at the different heights is controlled within a range of ±16 μm. In the two field curvature aberration diagrams of FIGS. 19B and 19C, the focal length variation of the three representative wavelengths in the entire field of view falls within ±20 μm. The distortion aberration diagram of FIG. 19D shows that the distortion aberration of the fourth embodiment is maintained within a range of ±3.5%.

It may be seen from the above description that the longitudinal spherical aberration, the field curvature aberration and the distortion aberration of the fourth embodiment are better than that of the first embodiment.

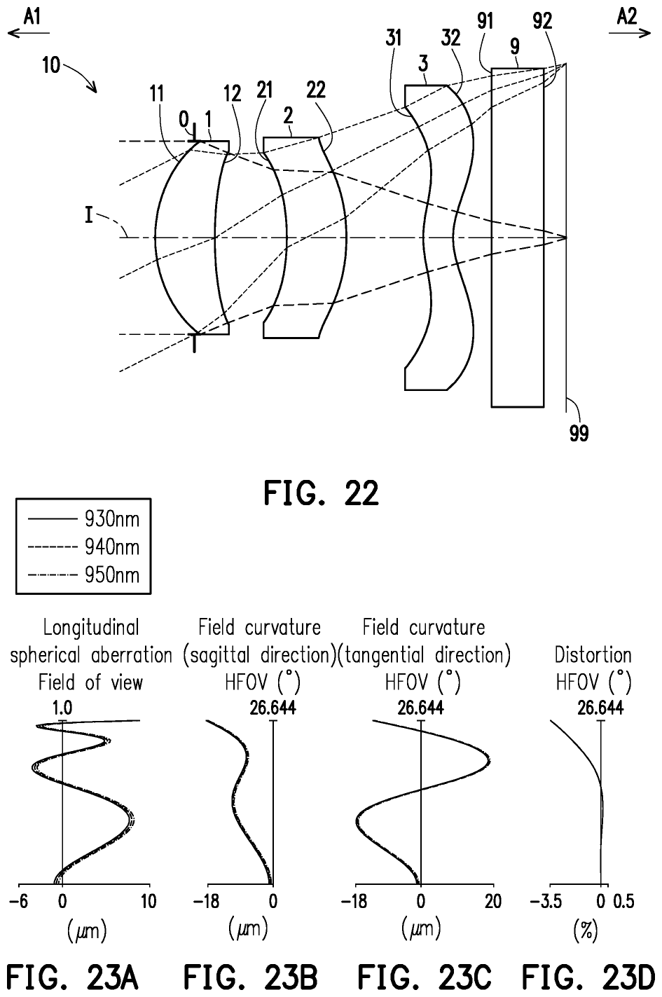

FIG. 22 is a schematic diagram of an optical imaging lens according to a fifth embodiment of the disclosure, and FIGS. 23A to 23D are diagrams of the longitudinal spherical aberration and various aberrations of the optical imaging lens according to the fifth embodiment. Referring to FIG. 22 first, the fifth embodiment of the optical imaging lens 10 of the disclosure is roughly similar to the first embodiment, except for the optical data, the aspheric surface coefficients, and the parameters of the lens elements 1, 2, and 3, which are more or less different. It should be noted here that, in order to clearly show the drawing, some of the reference numerals of the optical axis region and the periphery region similar to the first embodiment are omitted in FIG. 22.

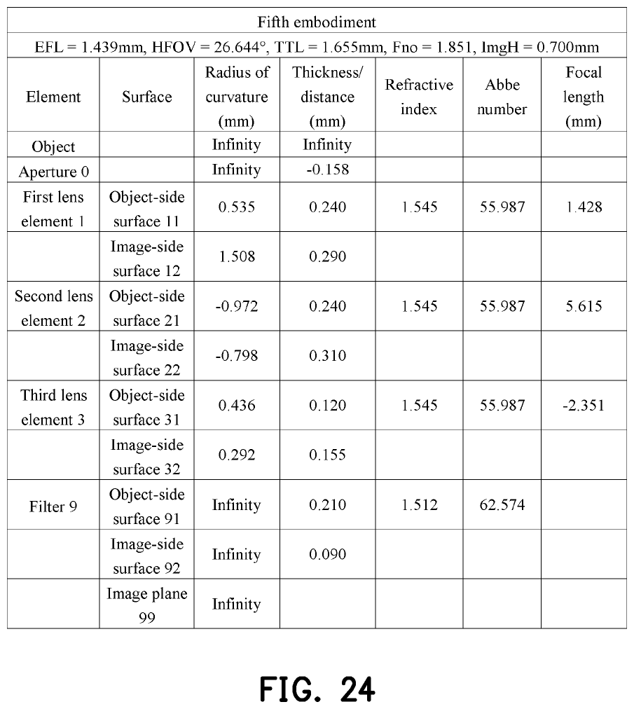

The detailed optical data of the optical imaging lens 10 according to the fifth embodiment is shown in FIG. 24. The effective focal length of the optical imaging lens 10 according to the fifth embodiment is 1.439 mm, the half field of view (HFOV) is 26.644 degrees, the F-number (Fno) is 1.851, the system length is 1.655 mm, and the image height is 0.700 mm.

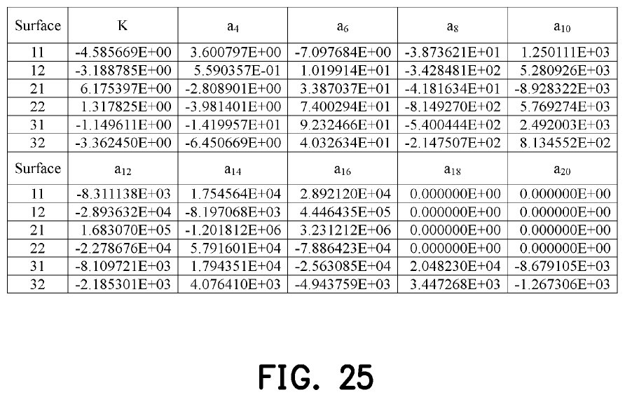

The aspheric surface coefficients of the object-side surface 11 of the first lens element 1 to the image-side surface 32 of the third lens element 3 according to the fifth embodiment in the formula (1) are shown in FIG. 25.

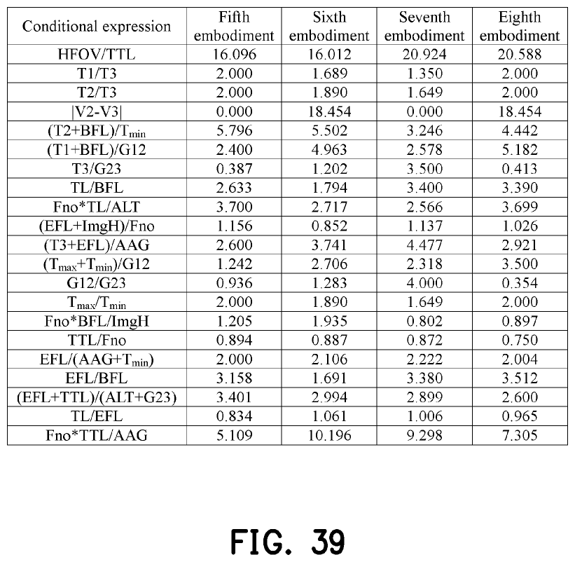

In addition, relationships between the important parameters of the optical imaging lens 10 according to the fifth embodiment are shown in FIG. 39.

The longitudinal spherical aberration of the fifth embodiment is shown in FIG. 23A, and the deviation of the imaging point of the off-axis rays at the different heights is controlled within a range of ±10 μm. In the two field curvature aberration diagrams of FIGS. 23B and 23C, the focal length variation of the three representative wavelengths in the entire field of view falls within ±20 μm. The distortion aberration diagram of FIG. 23D shows that the distortion aberration of the fifth embodiment is maintained within the range of ±3.5%.

It may be seen from the above description that the longitudinal spherical aberration, the field curvature aberration and the distortion aberration of the fifth embodiment are better than that of the first embodiment.

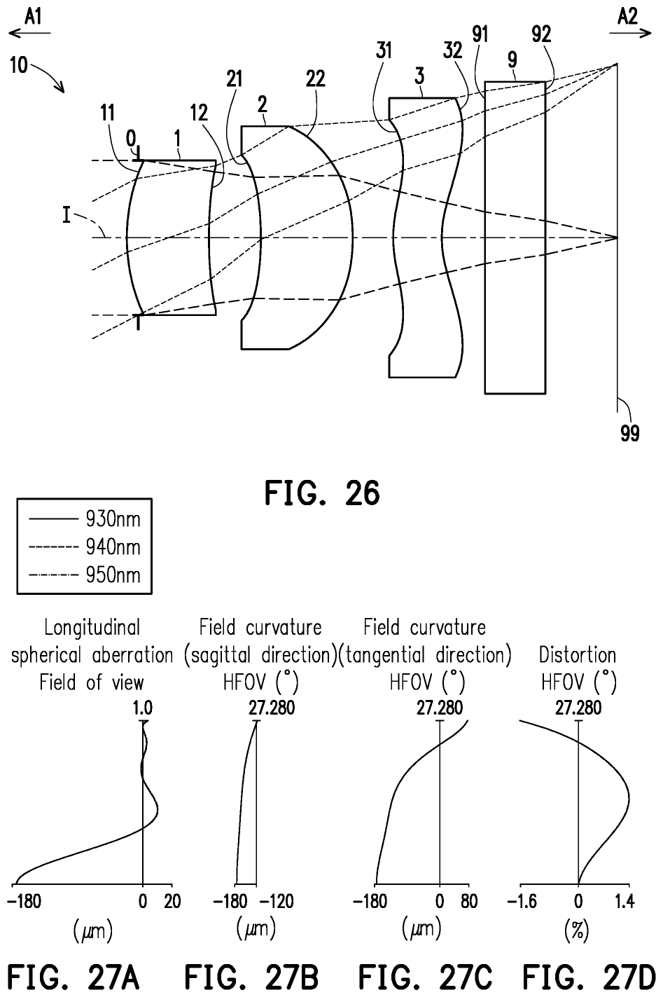

FIG. 26 is a schematic diagram of an optical imaging lens according to a sixth embodiment of the disclosure, and FIGS. 27A to 27D are diagrams of the longitudinal spherical aberration and various aberrations of the optical imaging lens according to the sixth embodiment. Referring to FIG. 26, the sixth embodiment of the optical imaging lens 10 of the disclosure is roughly similar to the first embodiment, except for the optical data, the aspheric surface coefficients, and the parameters of the lens elements 1, 2, and 3, which are more or less different. It should be noted here that, in order to clearly show the drawing, some of the reference numerals of the optical axis region and the periphery region similar to the first embodiment are omitted in FIG. 26.

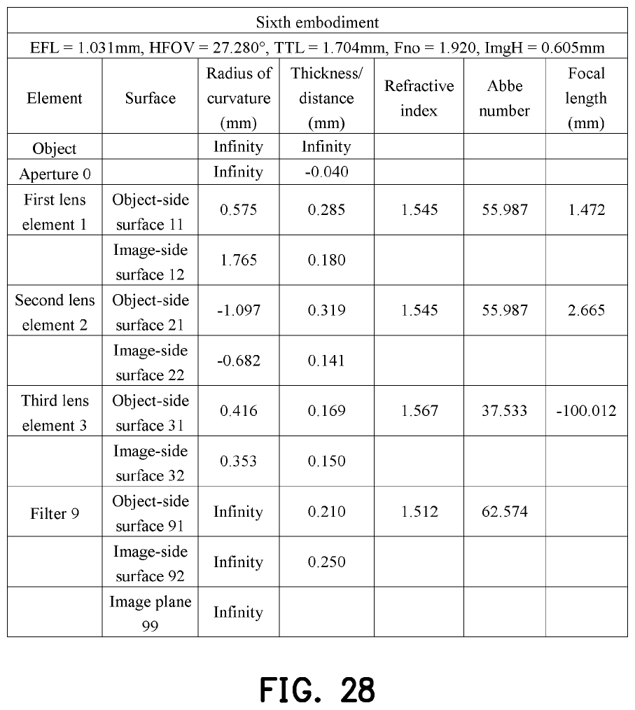

The detailed optical data of the optical imaging lens 10 according to the sixth embodiment is shown in FIG. 28. The effective focal length of the optical imaging lens 10 according to the sixth embodiment is 1.031 mm, the half field of view (HFOV) is 27.280 degrees, the F-number (Fno) is 1.920, the system length is 1.704 mm, and the image height is 0.605 mm.

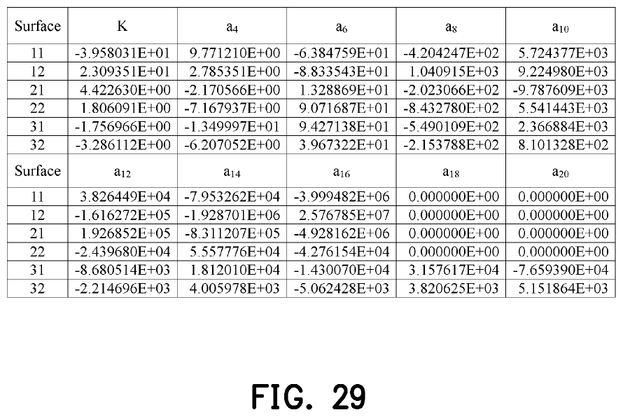

The aspheric surface coefficients of the object-side surface 11 of the first lens element 1 to the image-side surface 32 of the third lens element 3 according to the sixth embodiment in the formula (1) are shown in FIG. 29.

In addition, relationships between the important parameters of the optical imaging lens 10 according to the sixth embodiment are shown in FIG. 39.

The longitudinal spherical aberration of the sixth embodiment is shown in FIG. 27A, and the deviation of the imaging point of the off-axis rays at the different heights is controlled within a range of ±180 μm. In the two field curvature aberration diagrams of FIGS. 27B and 27C, the focal length variation of the three representative wavelengths in the entire field of view falls within ±180 μm. The distortion aberration diagram of FIG. 27D shows that the distortion aberration of the sixth embodiment is maintained within a range of ±1.6%.

It may be seen from the above description that the distortion aberration of the sixth embodiment is better than that of the first embodiment. In addition, a difference between the thickness of the optical axis and the periphery region of the lens in the sixth embodiment is smaller than that of the first embodiment, making it easier to manufacture and therefore has a higher yield.

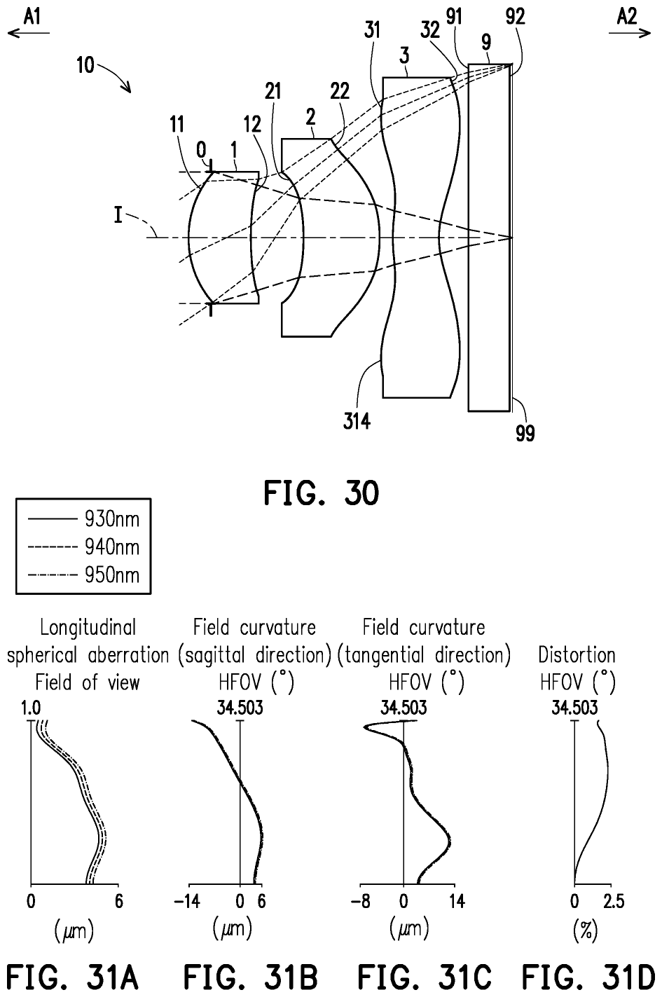

FIG. 30 is a schematic diagram of an optical imaging lens according to a seventh embodiment of the disclosure, and FIGS. 31A to 31D are diagrams of the longitudinal spherical aberration and various aberrations of the optical imaging lens according to the seventh embodiment. Referring to FIG. 30, the seventh embodiment of the optical imaging lens 10 of the disclosure is roughly similar to the first embodiment, except for the optical data, the aspheric surface coefficients, and the parameters of the lens elements 1, 2, and 3, which are more or less different. In addition, in the embodiment, the periphery region 314 of the object-side surface 31 of the third lens element 3 is convex. It should be noted here that, in order to clearly show the drawing, some of the reference numerals of the optical axis region and the periphery region similar to the first embodiment are omitted in FIG. 30.

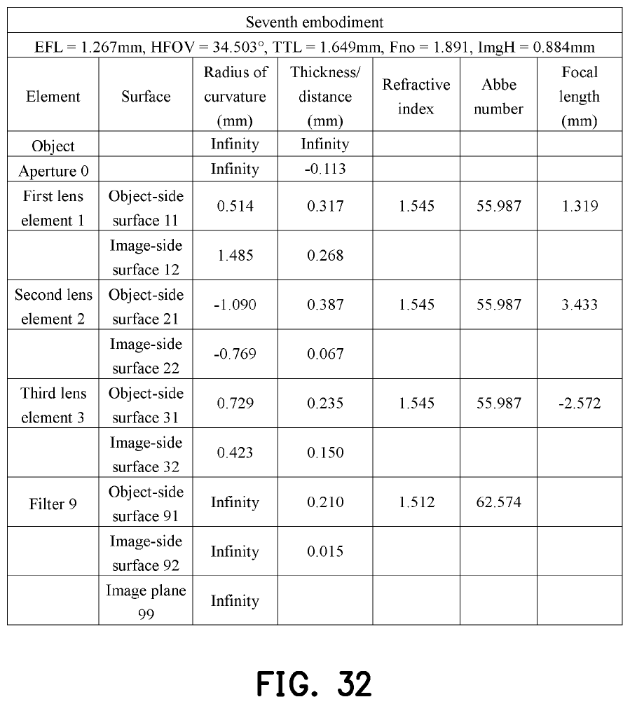

The detailed optical data of the optical imaging lens 10 according to the seventh embodiment is shown in FIG. 32. The effective focal length of the optical imaging lens 10 according to the seventh embodiment is 1.267 mm, the half field of view (HFOV) is 34.503 degrees, the F-number (Fno) is 1.891, the system length is 1.649 mm, and the image height is 0.884 mm.

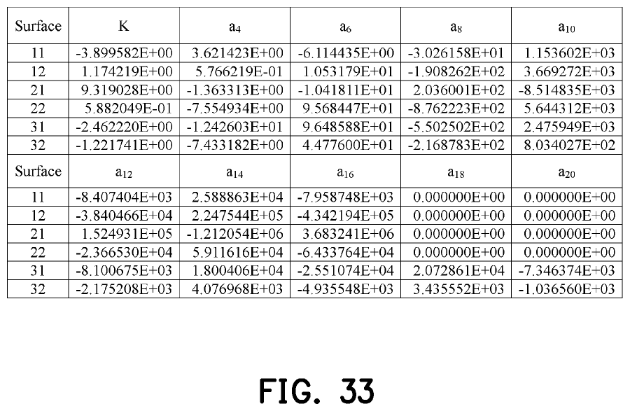

The aspheric surface coefficients of the object-side surface 11 of the first lens element 1 to the image-side surface 32 of the third lens element 3 according to the seventh embodiment in the formula (1) are shown in FIG. 33.

In addition, relationships between the important parameters of the optical imaging lens 10 according to the seventh embodiment are shown in FIG. 39.

The longitudinal spherical aberration of the seventh embodiment is shown in FIG. 31A, and the deviation of the imaging point of the off-axis rays at the different heights is controlled within a range of ±6 μm. In the two field curvature aberration diagrams of FIGS. 31B and 31C, the focal length variation of the three representative wavelengths in the entire field of view falls within ±14 μm. The distortion aberration diagram of FIG. 31D shows that the distortion aberration of the seventh embodiment is maintained within a range of ±2.5%.

It may be seen from the above description that the longitudinal spherical aberration, the field curvature aberration, and the distortion aberration of the seventh embodiment are better than those of the first embodiment.

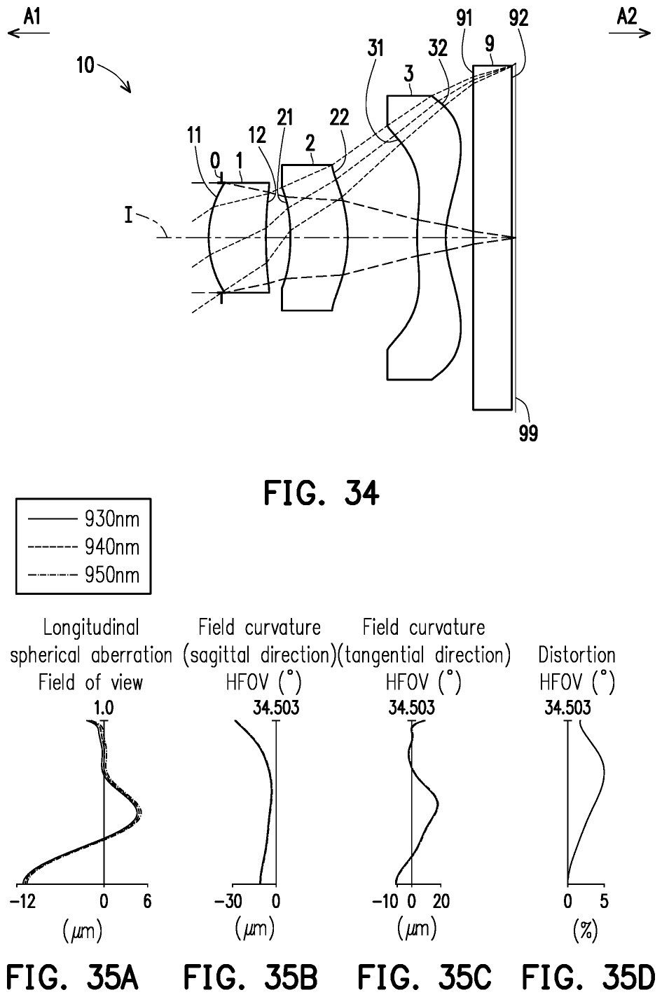

FIG. 34 is a schematic diagram of an optical imaging lens according to an eighth embodiment of the disclosure, and FIGS. 35A to 35D are diagrams of the longitudinal spherical aberration and various aberrations of the optical imaging lens according to the eighth embodiment. Referring to FIG. 34, the eighth embodiment of the optical imaging lens 10 of the disclosure is roughly similar to the first embodiment, except for the optical data, the aspheric surface coefficients, and the parameters of the lens elements 1, 2, and 3, which are more or less different. It should be noted here that, in order to clearly show the drawing, some of the reference numerals of the optical axis region and the periphery region similar to the first embodiment are omitted in FIG. 34.

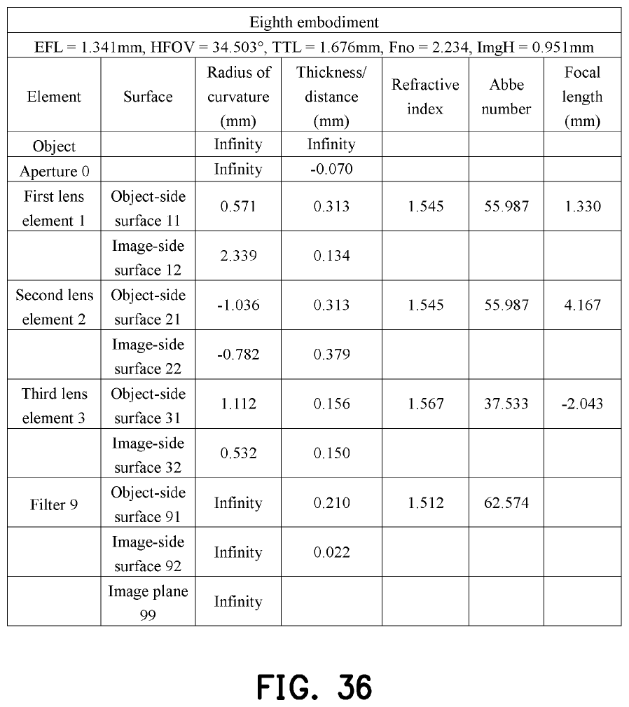

The detailed optical data of the optical imaging lens 10 according to the eighth embodiment is shown in FIG. 36. The effective focal length of the optical imaging lens 10 according to the eighth embodiment is 1.341 mm, the half field of view (HFOV) is 34.503 degrees, the F-number (Fno) is 2.234, the system length is 1.676 mm, and the image height is 0.951 mm.

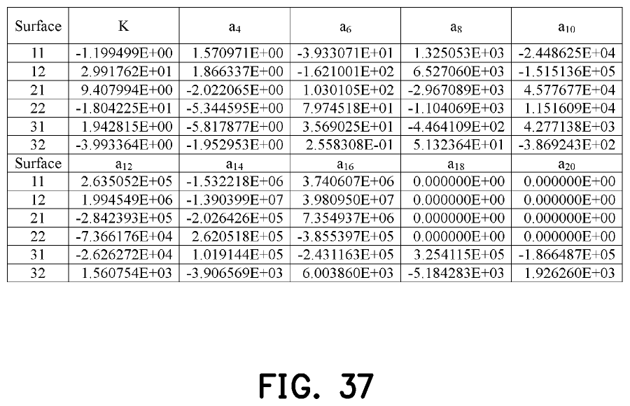

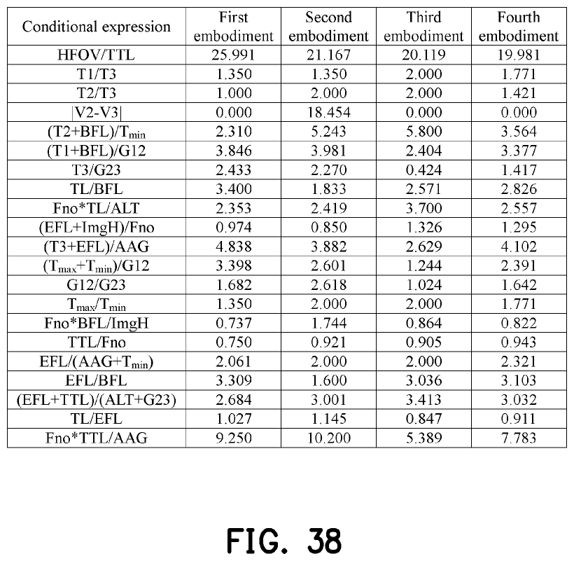

The aspheric surface coefficients of the object-side surface 11 of the first lens element 1 to the image-side surface 32 of the third lens element 3 according to the eighth embodiment in the formula (1) are shown in FIG. 37.

In addition, relationships between the important parameters of the optical imaging lens 10 according to the eighth embodiment are shown in FIG. 39.

The longitudinal spherical aberration of the eighth embodiment is shown in FIG. 35A, and the deviation of the imaging point of the off-axis rays at the different heights is controlled within a range of ±12 μm. In the two field curvature aberration diagrams of FIGS. 35B and 35C, the focal length variation of the three representative wavelengths in the entire field of view falls within ±30 μm. The distortion aberration diagram of FIG. 35D shows that the distortion aberration of the eighth embodiment is maintained within the range of ±5%.

It may be seen from the above description that the longitudinal spherical aberration of the eighth embodiment is better than that of the first embodiment.

Referring once again to FIGS. 38 and 39, FIGS. 38 and 39 are tabular diagrams of the various optical parameters of the first embodiment to the eighth embodiment.

The air gap between the lens elements or the thickness of the lens element should be moderately shortened or maintained at a certain ratio in order to shorten the system length of the optical imaging lens 10 and to ensure the imaging quality, while taking into consideration the difficulty of manufacturing. The embodiment of the disclosure is enabled to have a better configuration when the numerical value limitations of the following conditional expressions are satisfied.

The optical imaging lens 10 according to the embodiment of the disclosure meets a conditional expression as follows: (T2+BFL)/Tₘᵢₙ≤5.800, in which a preferred range is 2.100≤(T2+BFL)/Tₘᵢₙ≤5.800.

The optical imaging lens 10 according to the embodiment of the disclosure, which further meets a conditional expression as follows: (T1+BFL)/G12≥2.400, in which a preferred range is 2.400≤(T1+BFL)/G12≤4.200.

The optical imaging lens 10 according to the embodiment of the disclosure, which further meets a conditional expression as follows: T3/G23≤3.500, in which a preferred range is 0.600≤T3/G23≤3.500.

The optical imaging lens 10 according to the embodiment of the disclosure, which further meets a conditional expression as follows: TL/BFL≤3.400, in which a preferred range is 1.900≤TL/BFL≤3.400.

The optical imaging lens 10 according to the embodiment of the disclosure, which further meets a conditional expression as follows: (T3+EFL)/AAG≥2.600, in which a preferred range is 2.600≤(T3+EFL)/AAG≤5.300.

The optical imaging lens 10 according to the embodiment of the disclosure, which further meets a conditional expression as follows: (Tₘₐₓ+Tₘᵢₙ)/G12≤3.500, in which a preferred range is 0.800≤(Tₘₐₓ+Tₘᵢₙ)/G12≤3.500.

The optical imaging lens 10 according to the embodiment of the disclosure, which further meets a conditional expression as follows: G12/G23≤4.000, in which a preferred range is 1.300≤G12/G23≤4.000.

The optical imaging lens 10 according to the embodiment of the disclosure, which further meets a conditional expression as follows: Tₘₐₓ/Tₘᵢₙ≤2.000, in which a preferred range is 1.150≤Tₘₐₓ/Tₘᵢₙ≤2.000.

The optical imaging lens 10 according to the embodiment of the disclosure, which further meets a conditional expression as follows: EFL/(AAG+Tₘᵢₙ)≥2.000, in which a preferred range is 2.000≤EFL/(AAG+Tₘᵢₙ)≤3.000.

The optical imaging lens 10 according to the embodiment of the disclosure, which further meets a conditional expression as follows: EFL/BFL≥1.600, in which a preferred range is 1.600≤EFL/BFL≤6.300.

The optical imaging lens 10 according to the embodiment of the disclosure, which further meets a conditional expression as follows: (EFL+TTL)/(ALT+G23)≥2.600, in which a preferred range is 2.600≤(EFL+TTL)/(ALT+G23)≤4.200.

The optical imaging lens 10 according to the embodiment of the disclosure, which further meets a conditional expression as follows: TL/EFL≤2.000, in which a preferred range is 0.680≤TL/EFL≤2.000.

Furthermore, in the embodiment, a relational expression related to the F-number (Fno) is beneficial in reducing the Fno to increase the imaging rays intake of the optical imaging lens 10, so as to enable the disclosure to have a better optical quality when the relational expression satisfies conditional expressions as follows.

The optical imaging lens 10 according to the embodiment of the disclosure meets a conditional expression as follows: Fno*TL/ALT≤3.700, in which a preferred range is 2.100 Fno*TL/ALT≤3.700.

The optical imaging lens 10 according to the embodiment of the disclosure, which further meets a conditional expression as follows: (EFL+ImgH)/Fno≥0.850 mm, in which a preferred range is 0.850 mm≤(EFL+ImgH)/Fno≤1.450 mm.

The optical imaging lens 10 according to the embodiment of the disclosure, which further meets a conditional expression as follows: Fno*BFL/ImgH≤2.100, in which a preferred range is 0.450≤Fno*BFL/ImgH≤2.100.

The optical imaging lens 10 according to the embodiment of the disclosure, which further meets a conditional expression as follows: TTL/Fno≥0.750 mm, in which a preferred range is 0.750 mm≤TTL/Fno≤0.850 mm.

The optical imaging lens 10 according to the embodiment of the disclosure, which further meets a conditional expression as follows: Fno*TTL/AAG≤10.200, in which a preferred range is 3.650≤Fno*TTL/AAG≤10.200.

In addition, any combination of the parameters of the embodiment may be selected to increase the lens limit, so as to facilitate the lens design of the same architecture as the disclosure.

In view of the unpredictability of the optical system design, under the framework of the disclosure, meeting the above conditional expressions can better enable the disclosure to expand the field of view, shorten the system length, reduce the aperture value, improve the imaging quality, or improve the assembly yield. This may allow improvements over the shortcomings of the related art. Furthermore, the use of plastic material for the lens element of the embodiment of the disclosure can further reduce the weight of the optical imaging lens and save costs.

The numerical range including the maximum and minimum values obtained from the combination ratio relationship of the optical parameters disclosed in each embodiment of the disclosure can be implemented accordingly.

In summary, the optical imaging lens according to the embodiments of the disclosure can achieve at least one of the following.

Firstly, the longitudinal spherical aberration, the field curvature aberration, and the distortion of each embodiment of the disclosure are in compliance with the usage specifications. In addition, the three off-axis rays with the representative wavelengths of 930 nm, 940 nm, and 950 nm at the different heights are all concentrated near the imaging point. It can be seen from the deflection amplitude of each curve that the deviation of the imaging point of the off-axis rays of the different heights is controlled and has good spherical aberration, aberration, and distortion suppression abilities. With further reference to the imaging quality data, distances between the three representative wavelengths of 930 nm, 940 nm and 950 nm are also quite close to each other, which shows that the disclosure has good concentration of light of different wavelengths under various conditions and has excellent dispersion suppression ability. In summary, the disclosure can produce excellent imaging quality through the design and mutual collocation of the lens elements.

Secondly, the distortion and the aberration of the optical imaging lens can be corrected and improved by configuring a ratio of the surface shape or the refracting power design to the thickness of the first lens element and the third lens element when the periphery region of the image-side surface of the first lens element is designed to be concave, and the third lens element is designed to have negative refracting power, and conditional expressions of T1/T3≥1.350 and HFOV/TTL≥16.000 degrees/mm are satisfied. The optical imaging lens is enabled to reduce the size while having a large field of view when in compliance with the limit of HFOV/TTL≥16.000 degrees/mm. In addition, the optical imaging lens can achieve good imaging quality more easily when the optical axis region of the object-side surface of the second lens element is designed to be concave or the first lens element is designed to have positive refracting power. The preferred ranges of T1/T3 and HFOV/TTL are respectively 1.350≤T1/T3≤2.200 and 16.000 degrees/mm≤HFOV/TTL≤28.500 degrees/mm.

Thirdly, the distortion and the aberration of the optical imaging lens can be corrected and improved by the configuring a ratio of the surface shape or the refracting power of the first lens element and the third lens element to the thickness of the second lens element and the third lens element when the optical axis region of the image-side surface of the first lens element is designed to be concave, the third lens element is designed to have negative refracting power, the optical axis region of the object-side surface of the third lens element is designed to be convex, and a conditional expression of T2/T3≥1.000 is satisfied. The optical imaging lens is enabled to reduce the size while having a large field of view when in compliance with the limit of HFOV/TTL≥16.000 degrees/mm. The chromatic aberration can be effectively eliminated and unnecessary stray light is reduced when |V2−V3|≤20.000 is further satisfied. The preferred implementation ranges of T2/T3, HFOV/TTL and |V2−V3| are respectively 1.000≤T2/T3≤2.700, 16.000 degrees/mm≤HFOV/TTL≤28.500 degrees/mm and 0.000≤|V2−V3|≤20.000.

Fourthly, the aspheric surface design of the lens element according to each embodiment of the disclosure is more favorable to the optimization of the imaging quality.

Lastly, the choice of plastic material for the lens element according to each embodiment of the disclosure helps to lighten the weight, which can further reduce the weight of the optical imaging lens and save costs.

The contents in the embodiments of the invention include but are not limited to a focal length, a thickness of a lens element, an Abbe number, or other optical parameters. For example, in the embodiments of the invention, an optical parameter A and an optical parameter B are disclosed, wherein the ranges of the optical parameters, comparative relation between the optical parameters, and the range of a conditional expression covered by a plurality of embodiments are specifically explained as follows:

(1) The ranges of the optical parameters are, for example, α₂≤A≤α₁, or β₂≤B≤β₁, where α₁ is a maximum value of the optical parameter A among the plurality of embodiments, α₂ is a minimum value of the optical parameter A among the plurality of embodiments, β₁ is a maximum value of the optical parameter B among the plurality of embodiments, and β₂ is a minimum value of the optical parameter B among the plurality of embodiments.
(2) The comparative relation between the optical parameters is that A is greater than B, or A is less than B, for example.
(3) The range of a conditional expression covered by a plurality of embodiments is in detail a combination relation or proportional relation obtained by a possible operation of a plurality of optical parameters in each same embodiment. The relation is defined as E, and E is, for example, A+B, or A−B, or A/B, or A*B, or (A*B)^{1/2}, and E satisfies a conditional expression E≤γ₁, or E≥γ₂, or γ₂≤E≤γ₁, where each of γ₁ and γ₂ is a value obtained by an operation of the optical parameter A and the optical parameter B in a same embodiment, γ₁ is a maximum value among the plurality of the embodiments, and γ₂ is a minimum value among the plurality of the embodiments.

The ranges of the aforementioned optical parameters, the aforementioned comparative relations between the optical parameters, and a maximum value, a minimum value, and the numerical range between the maximum value and the minimum value of the aforementioned conditional expressions are all implementable and all belong to the scope disclosed by the invention. The aforementioned description is for exemplary explanation, but the invention is not limited thereto.

The embodiments of the invention are all implementable. In addition, a combination of partial features in a same embodiment can be selected, and the combination of partial features can achieve the unexpected result of the invention with respect to the prior art. The combination of partial features includes but is not limited to the surface shape of a lens element, a refracting power, a conditional expression or the like, or a combination thereof. The description of the embodiments is for explaining the specific embodiments of the principles of the invention, but the invention is not limited thereto. Specifically, the embodiments and the drawings are for exemplifying, but the invention is not limited thereto.

Although the disclosure has been disclosed with the foregoing exemplary embodiments, it is not intended to limit the disclosure. Any person skilled in the art can make various changes and modifications within the spirit and scope of the disclosure. Accordingly, the scope of the disclosure is defined by the claims appended hereto and their equivalents.

What is claimed is:

1. An optical imaging lens, comprising a first lens element, a second lens element, and a third lens element sequentially disposed from an object side to an image side along an optical axis, wherein each of the first lens element to the third lens element comprises an object-side surface that faces the object side and allows an imaging ray to pass through, and an image-side surface that faces the image side and allows the imaging ray to pass through,
a periphery region of the image-side surface of the first lens element is concave,
an optical axis region of the object-side surface of the second lens element is concave,
the third lens element has negative refracting power,
wherein lens elements of the optical imaging lens are only the above three lens elements, and the optical imaging lens satisfies conditional expressions as follows: HFOV/TTL≥16.000 degrees/mm and T1/T3≥1.350, where HFOV is a half field of view of the optical imaging lens, TTL is a distance from the object-side surface of the first lens element to an image plane on the optical axis, T1 is a thickness of the first lens element on the optical axis, and T3 is a thickness of the third lens element on the optical axis.

2. The optical imaging lens according to claim 1, wherein the optical imaging lens further satisfies a conditional expression as follows: (T2+BFL)/Tₘᵢₙ≤5.800, where T2 is a thickness of the second lens element on the optical axis, BFL is a distance from the image-side surface of the third lens element to the image plane on the optical axis, and Tₘᵢₙ is a minimum value of the three lens elements thicknesses of the first lens element to the third lens element on the optical axis.

3. The optical imaging lens according to claim 1, wherein the optical imaging lens further satisfies a conditional expression as follows: (T1+BFL)/G12≥2.400, where BFL is a distance from the image-side surface of the third lens element to the image plane on the optical axis, and G12 is an air gap between the first lens element and the second lens element on the optical axis.

4. The optical imaging lens according to claim 1, wherein the optical imaging lens further satisfies a conditional expression as follows: T3/G23≤3.500, where G23 is an air gap between the second lens element and the third lens element on the optical axis.

5. The optical imaging lens according to claim 1, wherein the optical imaging lens further satisfies a conditional expression as follows: TL/BFL≤3.400, where TL is a distance from the object-side surface of the first lens element to the image-side surface of the third lens element on the optical axis, and BFL is a distance from the image-side surface of the third lens element to the image plane on the optical axis.

6. The optical imaging lens according to claim 1, wherein the optical imaging lens further satisfies a conditional expression as follows: Fno*TL/ALT≤3.700, where Fno is an F-number of the optical imaging lens, TL is a distance from the object-side surface of the first lens element to the image-side surface of the third lens element on the optical axis, and ALT is a sum of the thicknesses of the three lens elements, from the first lens element to the third lens element on the optical axis.

7. The optical imaging lens according to claim 1, wherein the optical imaging lens further satisfies a conditional expression as follows: (EFL+ImgH)/Fno≥0.850 mm, where EFL is an effective focal length of the optical imaging lens, ImgH is an image height of the optical imaging lens, and Fno is an F-number of the optical imaging lens.

8. An optical imaging lens, comprising a first lens element, a second lens element, and a third lens element disposed sequentially from an object side to an image side along an optical axis, wherein each of the first lens element to the third lens element comprises an object-side surface that faces the object side and allows an imaging ray to pass through, and an image-side surface that faces the image side and allows the imaging ray to pass through,
the first lens element has positive refracting power, and a periphery region of the image-side surface is concave,
the third lens element has negative refracting power,
wherein lens elements of the optical imaging lens are only the above three lens elements, and the optical imaging lens satisfies conditional expressions as follows: HFOV/TTL≥16.000 degrees/mm and T1/T3≥1.350, where HFOV is a half field of view of the optical imaging lens, TTL is a distance from the object-side surface of the first lens element to an image plane on the optical axis, T1 is a thickness of the first lens element on the optical axis, and T3 is a thickness of the third lens element on the optical axis.

9. The optical imaging lens according to claim 8, wherein the optical imaging lens further satisfies a conditional expression as follows: (T3+EFL)/AAG≥2.600, where EFL is an effective focal length of the optical imaging lens, and AAG is a sum of two air gaps from the first lens element to the third lens element on the optical axis.

10. The optical imaging lens according to claim 8, wherein the optical imaging lens further satisfies a conditional expression as follows: (Tₘₐₓ+Tₘᵢₙ)/G12≤3.500, where Tₘₐₓ is a maximum value of three lens elements thicknesses of the first lens element to the third lens element on the optical axis, Tₘᵢₙ, is a minimum value of the three lens elements thicknesses of the first lens element to the third lens element on the optical axis, and G12 is an air gap between the first lens element and the second lens element on the optical axis.

11. The optical imaging lens according to claim 8, wherein the optical imaging lens further satisfies a conditional expression as follows: G12/G23≤4.000, where G12 is an air gap between the first lens element and the second lens element on the optical axis, and G23 is an air gap between the second lens element and the third lens element on the optical axis.

12. The optical imaging lens according to claim 8, wherein the optical imaging lens further satisfies a conditional expression as follows: Tₘₐₓ/Tₘᵢₙ≤2.000, where Tₘₐₓ is a maximum value of three lens elements thicknesses of the first lens element to the third lens element on the optical axis, and Tₘᵢₙ is a minimum value of the three lens elements thicknesses of the first lens element to the third lens element on the optical axis.

13. The optical imaging lens according to claim 8, wherein the optical imaging lens further satisfies a conditional expression as follows: Fno*BFL/ImgH≤2.100, where Fno is an F-number of the optical imaging lens, BFL is a distance from the image-side surface of the third lens element to the image plane on the optical axis, and ImgH is an image height of the optical imaging lens.

14. The optical imaging lens according to claim 8, wherein the optical imaging lens further satisfies a conditional expression as follows: TTL/Fno≥0.750 mm, where Fno is an F-number of the optical imaging lens.

15. An optical imaging lens, comprising a first lens element, a second lens element, and a third lens element sequentially disposed from an object side to an image side along an optical axis, wherein each of the first lens element to the third lens element comprises an object-side surface that faces the object side and allows an imaging ray to pass through, and an image-side surface that faces the image side and allows the imaging ray to pass through,
an optical axis region of the image-side surface of the first lens element is concave,
the third lens element has negative refracting power, and an optical axis region of the object-side surface is convex,
wherein lens elements of the optical imaging lens are only the above three lens elements, and the optical imaging lens satisfies conditional expressions as follows: HFOV/TTL≥16.000 degrees/mm, T2/T3≥1.000 and |V2−V3|≤20.000, where HFOV is a half field of view of the optical imaging lens, TTL is a distance from the object-side surface of the first lens element to an image plane on the optical axis, T2 is a thickness of the second lens element on the optical axis, T3 is a thickness of the third lens element on the optical axis, V2 is an Abbe number of the second lens element, and V3 is an Abbe number of the third lens element.

16. The optical imaging lens according to claim 15, wherein the optical imaging lens further satisfies a conditional expression as follows: EFL/(AAG+Tₘᵢₙ)≥2.000, where EFL is an effective focal length of the optical imaging lens, AAG is a sum of two air gaps from the first lens element to the third lens element on the optical axis, and Tₘᵢₙ is a minimum value of the three lens elements thicknesses of the first lens element to the third lens element on the optical axis.

17. The optical imaging lens according to claim 15, wherein the optical imaging lens further satisfies a conditional expression as follows: EFL/BFL≥1.600, where EFL is an effective focal length of the optical imaging lens and BFL is a distance from the image-side surface of the third lens element to the image plane on the optical axis.

18. The optical imaging lens according to claim 15, wherein the optical imaging lens further satisfies a conditional expression as follows: (EFL+TTL)/(ALT+G23)≥2.600, where EFL is an effective focal length of the optical imaging lens, ALT is a sum of the thicknesses of the three lens elements, from the first lens element to the third lens element on the optical axis, and G23 is an air gap between the second lens element and the third lens element on the optical axis.

19. The optical imaging lens according to claim 15, wherein the optical imaging lens further satisfies a conditional expression as follows: TL/EFL≤2.000, where TL is a distance from the object-side surface of the first lens element to the image-side surface of the third lens element on the optical axis and EFL is an effective focal length of the optical imaging lens.

20. The optical imaging lens according to claim 15, wherein the optical imaging lens further satisfies a conditional expression as follows: Fno*TTL/AAG≤10.200, where Fno is an F-number of the optical imaging lens and AAG is a sum of two air gaps from the first lens element to the third lens element on the optical axis.
